(19) United States
(12) Patent Application Publication
(10) Pub. No.: US 2026/0225411 A1
(43) Pub. Date: Aug. 6, 2026

(54) METHOD FOR DETECTING AN EXCHANGE OF A WHEEL UNIT OR A SENSOR DEVICE, TIRE PRESSURE CONTROL SYSTEM, ELECTRONIC CONTROL UNIT AND VEHICLE

(71) Applicant: ZF CV Systems Europe BV, Brussels (BE)

(72) Inventors: Jan Leon Kaminski, Hannover (DE); Lennart Thimm, Lehrte (DE)

(21) Appl. No.: 19/575,815

(22) Filed: Mar. 23, 2026

Related U.S. Application Data
(63) Continuation of application No. PCT/EP2024/079329, filed on Oct. 17, 2024.

(30) Foreign Application Priority Data
Nov. 14, 2023 (DE) 10 2023 131 689.3

(51) Int. Cl. B60C 23/04; G01L 17/00; G07C 5/08

(52) U.S. Cl. CPC B60C 23/0416; G01L 17/00; G07C 5/0841

(57) ABSTRACT

A method is for detecting replacement of a wheel unit having a sensor device or replacement of the sensor device of the wheel unit of a vehicle having a tire pressure monitoring system. The sensor device is configured to sense a tire pressure parameter and to transmit sensor signals to a receiving device of the tire pressure monitoring system. A plurality of sensor signal criteria of the transmitted sensor signal are evaluated in order to determine a combination of sensor signal values. On the basis of the combination of sensor signal values, replacement of the wheel unit or of the sensor device is detected. A tire pressure monitoring system is for a vehicle, an electronic control unit is for a tire pressure monitoring system, and a vehicle includes the electronic control unit and/or the pressure monitoring system.

### CROSS-REFERENCE TO RELATED APPLICATIONS

This application is a continuation application of international patent application PCT/EP2024/079329, filed October 17, 2024, designating the United States and claiming priority from German application 102023131 689.3, filed November 14, 2023, and the entire content of both applications is incorporated herein by reference.

### TECHNICAL FIELD

The disclosure relates to a method for detecting replacement of a wheel unit having a sensor device or replacement of the sensor device of the wheel unit of a vehicle having a tire pressure monitoring system. The disclosure furthermore relates to a tire pressure monitoring system for a vehicle, to an electronic control unit for a tire pressure monitoring system, and to a vehicle, in particular a commercial vehicle.

### BACKGROUND

Tire pressure monitoring systems are used to monitor a tire pressure parameter on vehicle wheels in order to avoid accident risks and increased fuel consumption. The tire pressure parameter may be sensed, for example, as tire pressure directly via a tire pressure sensor or be indirectly derived from other variables, for example from a tire pressure-dependent change in the rolling circumference of the tires or frequency effects of the vibrations of rim-tire combinations, these being able to be sensed, for example, by wheel speed sensors. The values sensed by sensors and directly or indirectly representing a tire pressure can be transmitted, for example, by radio to a tire pressure control unit of the vehicle. In order for it to be possible to assign the transmitted values to a respective wheel position, manual and automatic assignment methods are known, via which, for example, an identification code of a sensor unit can be linked to a wheel position.

A technical challenge arises in the case of tire pressure monitoring systems during replacement of a wheel unit or of a sensor device of a wheel unit of the vehicle, if such an exchange is intended to be detected automatically. In particular, it is possible, for example, in the event of an unplanned replacement of a wheel unit, for the type of the sensor device on the wheel unit to be changed, and so type-independent automatic replacement detection is desirable. At the same time, a high level of detection reliability is desirable so as not to impair the system integrity of the tire pressure monitoring system as a result of erroneous detections.

KR 100783958 B1 discloses a method in which temperature information from a tire pressure monitoring sensor is used to identify whether a spare wheel is being used as a replacement wheel.

KR 100680342 B1 describes a method in which acceleration information from a tire pressure monitoring sensor is used to identify whether a spare wheel is being used as a replacement wheel.

KR 1020150022448 A relates to a method in which rotation angle information from a tire pressure monitoring sensor and a wheel speed sensor are used to identify whether a spare wheel is being used as a replacement wheel.

DE 102018104673 A1 discloses a method for assigning tire pressure monitoring units mounted on wheels of a vehicle to wheel positions of the vehicle, wherein signals from ABS sensors and level fluctuations of signals from the tire pressure monitoring units are evaluated.

DE 102020106754 A1 describes a method for automatically assigning tire pressure sensors to a wheel position by evaluating sensor data from the tire pressure sensors and assigning wheel speed sensors to the wheel positions using measured signal strengths and sensed rotation angle positions of the wheels.

### SUMMARY

According to the features of an embodiments, a method for detecting replacement of a wheel unit having a sensor device or replacement of the sensor device of the wheel unit of a vehicle having a tire pressure monitoring system is proposed, wherein the sensor device is configured to sense a tire pressure parameter and to transmit sensor signals to a receiving device of the tire pressure monitoring system, and wherein a plurality of sensor signal criteria of the transmitted sensor signal are evaluated in order to determine a combination of sensor signal values, and, on the basis of the combination of sensor signal values, replacement of the wheel unit or of the sensor device is detected.

In other words, a method for detecting replacement of the wheel unit or of the sensor device is provided, in which a statistical decision basis is made possible by a common evaluation of a plurality of sensor signal criteria, and this makes it possible to correctly conclude with high probability that replacement of the component has been carried out. In this case, replacement of the wheel unit or of the sensor device can be reliably detected using characteristic combinations of sensor signal values.

The proposed method can allow automated replacement detection without user intervention. Not only does this increase user convenience, but also the tire pressure monitoring system is also immediately ready for use with regard to the replaced wheel unit or sensor device, with the result that a high safety level can be maintained. As a result of the common evaluation of a plurality of factors, the method has a low susceptibility to error, thereby increasing the system integrity of the tire pressure monitoring system. In this case, risks of non-detection and of erroneous detection of replacement of the wheel unit or of the sensor device, that is, of unintended reassignment of a sensor device to a wheel position, can be significantly reduced. In this case, the proposed method is largely independent of a used sensor type, vehicle type or a user intervention, and so a high degree of autonomy can be achieved. The sensor signal criteria used for the evaluation can be flexibly defined and extended or replaced at any time without significant effort, thereby making an adaptable evaluation process possible, which can be developed further for example with sensor types, vehicle types and tire pressure monitoring methods that will be available in the future.

A wheel unit may be formed from a wheel of the vehicle and from a sensor device arranged on the wheel. The sensor device may be configured to generate and transmit sensor signals. A sensor signal may represent a variable sensed via a sensor element of the sensor device on the wheel, for example a tire pressure or a wheel acceleration. A sensor signal may furthermore be an operation-related sensor status signal, for example a battery status of the sensor device. Sensor signals can be transmitted in particular wirelessly to a receiving device of the tire pressure monitoring system. The receiving device of the tire pressure monitoring system can be assigned, for example, to an electronic control unit of the tire pressure monitoring system of the vehicle, in which an evaluation of the received sensor signals can be carried out, for example, via a signal processing unit in the form of a processor. The vehicle may be in particular a commercial vehicle, for example a towing vehicle, a trailer vehicle or a vehicle combination of a towing vehicle and a trailer vehicle.

According to the proposed method, a plurality of sensor signal criteria of the transmitted sensor signal are evaluated. A plurality can be understood as being a number of at least two, in particular of at least three or at least four sensor signal criteria. Sensor signal criteria can include, for example, the sensor values with regard to a variable sensed by a sensor element of the sensor device or an operation-related sensor status, or be related to defined properties of the sensor signal, for example to a signal strength of the sensor signal. In this case, particular sensor values or statuses or properties of the sensor signal can correlate with a replaced wheel unit or with a replaced sensor device and accordingly represent direct or indirect indicators that a replacement has been carried out. As part of the evaluation, a combination of sensor signal values is created using the evaluated sensor signal criteria, this forming a decision basis for the intended replacement detection. In this case, one sensor signal value can represent one sensor signal criterion in each case. According to one conceivable embodiment, a qualitative evaluation can be carried out, in which, for example, a check is made as to whether a sensor signal criterion has or has not been fulfilled, and an associated sensor signal value is determined depending on the result of the check. Such a sensor signal value may be, for example, a truth value. Alternatively or additionally, a quantitative evaluation can be carried out, in which, for example, a metric or a probability value of the sensor signal criterion is determined and an associated sensor signal value is determined depending on the result. In this case, the sensor signal value can correspond to the quantitative value, for example to the metric or the probability value. It is conceivable to combine qualitative and quantitative evaluations, for example to determine one sensor signal criterion qualitatively and a further sensor signal criterion quantitatively.

According to one embodiment, the plurality of sensor signal criteria may include one of the following sensor signal criteria:

a battery warning signal;

a pressure loss warning signal;

a sensor loss signal;

a signal strength fluctuation of the sensor signal;

an acceleration signal;

a direction of rotation signal; and/or

a driving status signal.

The abovementioned sensor signal criteria may advantageously be used for detecting replacement of a wheel unit or of a sensor device, since they represent suitable indicators for such a replacement. The abovementioned sensor signal criteria can be sensed using sensor signals from the sensor device that are already provided to the tire pressure monitoring system, or can be additionally determined in a simple manner. In this case, it is not necessary to provide additional sensors on the wheel unit or on the vehicle in order to detect replacement of the wheel unit or of the sensor device. The abovementioned sensor signal criteria represent unambiguous factors that are easy to sense, and can be evaluated easily. Following transmission to the receiving device, the sensor signals may be stored, for example, in a storage unit of an electronic control unit of the tire pressure monitoring system, such that the electronic control unit can also use the abovementioned sensor signal criteria for evaluation at a later time after the sensor signal has been received at the receiving device. Thus, at the time of a sensor signal criterion evaluation, it is possible to carry out a retroactive check as to whether, for example, a battery warning signal or a pressure loss warning signal has been transmitted.

For example, a battery warning signal may represent information relating to the dropping below of a predefined battery voltage of the sensor device and may be an indicator for replacement of the sensor device.

A pressure loss warning signal may represent information relating to the dropping below of a predefined tire pressure of the wheel of the wheel unit and may be an indicator for replacement of the wheel unit. In this case, it is possible to take several types of pressure loss warning signals into consideration. For example, a distinction can be made between a slight and a significant pressure loss, which can respectively represent different sensor signal criteria or can form a common sensor signal criterion with different characteristics or probability values. A pressure loss warning signal indicating a significant loss of pressure can correlate with a higher probability of replacement of the wheel unit.

A sensor loss signal can be generated, for example, if no sensor signal from the sensor device has been received at the receiving device for a predefined period of time, with the result that a sensor loss is able to be derived, for example, from a corresponding time-out signal. A sensor loss signal may indicate a defective or removed sensor device and may be an indicator for replacement of the sensor device or of the wheel unit having the sensor device. The sensor loss signal can be generated directly in an electronic control unit of the tire pressure monitoring system and be stored in a storage unit of the tire pressure monitoring system. Compared with the other described sensor signal criteria, a sensor loss signal can be associated with a high probability of replacement of the sensor device or of the wheel unit, and so, in some embodiments, this sensor signal criterion can be given greater significance, in particular a higher weighting, in a common evaluation of sensor signal criteria.

A signal strength fluctuation of the sensor signal can correspond to a change in a signal strength of the sensor signal received at the receiving device over time. A signal strength of the sensor signal can be represented, for example, via an RSSI value, wherein an RSSI value (Received Signal Strength Indicator) is a measure of the reception field strength of the wirelessly transmitted sensor signal. If a wheel unit having the sensor device moves relative to the vehicle having the tire pressure monitoring system, the signal strength can fluctuate measurably, for example even periodically at a constant speed, on account of a distance between the sensor device and the receiving device that is variable as the wheel rotates. However, if, for example, it is detected that a signal strength fluctuation of the sensor signal is abruptly reduced or is no longer measurable or is, for example, within a predefined tolerance band, this may indicate that the wheel unit or the sensor device sending the sensor signal has been removed from its original wheel position and is arranged, for example, in a spare wheel mount or on a loading surface of the vehicle. Accordingly, a signal strength fluctuation of the sensor signal that is changed or is too low can be an indicator that a wheel unit or a sensor device assigned to a wheel of the vehicle has been replaced. The above-described sensor signal criterion can also be referred to as RSSI plausibility, since an RSSI plausibility check is carried out during the evaluation of the sensor signal criterion to determine whether a signal strength of the received sensor signal lies within or outside a fluctuation range customary for a wheel rotation.

An acceleration signal can be provided, for example, by a suitable acceleration sensor element of the sensor device and be transmitted to the receiving device in addition to the variable sensed by the sensor device in order to determine or monitor the tire pressure. The acceleration signal can reproduce, in particular, a rotational acceleration of the sensor device on the assigned wheel. If a predefined acceleration value of the acceleration signal is dropped below for a relatively long time and in the case, in particular, of a reduced acceleration value compared with acceleration signals from further wheel units of the vehicle, it is possible to conclude that the wheel unit sending the sensor signal or the sensor device has been removed from its original wheel position and is arranged, for example, in a spare wheel mount or on a loading surface of the vehicle. Accordingly, an acceleration signal value of the sensor signal that is too low or deviates from other acceleration values can be an indicator that a wheel unit or a sensor device assigned to a wheel of the vehicle has been replaced. The above-described sensor signal criterion can also be referred to as acceleration status plausibility, since during the evaluation of the sensor signal criterion, a plausibility check is carried out to determine whether an acceleration value of the received sensor signal lies within or outside a value range customary for a wheel rotation. Alternatively or additionally, it is possible, for example, to carry out a check as to whether the acceleration value matches acceleration values of other wheel units.

A direction of rotation signal can be provided, for example, by a suitable direction of rotation sensor element, for example a Hall sensor, of the sensor device and be transmitted to the receiving device in addition to the variable sensed by the sensor device in order to determine or monitor the tire pressure. The direction of rotation signal can reproduce, in particular, a direction of rotation of the sensor device on the assigned wheel. If no direction of rotation information is provided for a relatively long time, it is possible to conclude that the wheel unit sending the sensor signal or the sensor device has been removed from its original wheel position and is arranged, for example, in a spare wheel mount or on a loading surface of the vehicle. Accordingly, a change in the direction of rotation information from an existing direction of rotation signal to no direction of rotation signal of the sensor signal can be an indicator that a wheel unit or a sensor device assigned to a wheel of the vehicle has been replaced.

A driving status signal may be, for example, a time-dependently sensed criterion of the wheel unit, for example acceleration- or speed-dependently determined standstill or driving time information, which can be provided depending on the configuration of the sensor device or can be determined by evaluation of the sensor signals in a control unit of the tire pressure monitoring system. Via the driving status signal, it is possible, for example, for short or longer standstill times of the wheel unit to be able to be detected and evaluated. The driving status signal can be used as a sensor signal criterion for detecting replacement of the sensor device or wheel unit, for example when a standstill time of the wheel unit is reported to the receiving device, while a driving time for the period in question is transmitted by further wheel units of the vehicle. Furthermore, the driving status signal can be used to initiate a checking process for detecting replacement of the wheel unit or of the sensor device, since, for example, a relatively long standstill time of all the wheel units can be an indicator for a possible replacement of a wheel unit in the sense of a wheel change. Conversely, it is possible, for example, in the case of a relatively long continuous driving time, to assume that there is currently no need to check for replacement.

According to one embodiment, to determine the combination of sensor signal values, a check can be made as to whether the plurality of sensor signal values each fulfill a predefined condition. This allows easy evaluation of the combination of sensor signal values with unambiguous results. For instance, a binary evaluation result can be determined for each sensor signal value, for example a truth value with the result options "true" and "untrue", such that a simple comparison of the evaluation results with possible binary comparison combination series of the sensor signal criteria can be carried out. With regard to the above-described sensor signal criteria, it is possible, for example, to use a binary evaluation result to check whether a battery warning signal exists, whether a pressure loss warning signal exists, whether a sensor loss signal exists, whether a signal strength of the received sensor signal lies outside a fluctuation range customary for a wheel rotation, whether an acceleration value of the received sensor signal lies outside a value range customary for a wheel rotation, or whether an acceleration value of the received sensor signal does not match acceleration values of other wheel units, whether a direction of rotation signal exists and/or whether a standstill time has been detected.

According to one embodiment, the determined combination of sensor signal values can be compared with stored comparison combinations of sensor signal values, wherein each comparison combination of sensor signal values is assigned a result value. This allows a secure and reliable evaluation with an unambiguous conclusion based on predefined result values. According to one embodiment, binary result values can be provided, for example in the sense of "replacement occurring" or "no replacement occurring". This allows a relatively simple configuration of the method, which can advantageously be combined, for example, with binary sensor signal values. Alternatively, a more highly differentiated evaluation with a plurality of possible result values is conceivable, for example with gradations in the sense of "replacement very likely", "replacement likely", "replacement unlikely" or "replacement very unlikely". Furthermore, it is possible to provide result values in the form of probability values, for example in the sense of "75 percent replacement probability". As a result of greater differentiation via a plurality of possible result values, it is possible, for example, for different follow-up actions to be afforded or carried out. For instance, a reassignment based on a determined probability value can be made depending on selected user settings or an optional additional user input can be requested.

According to one embodiment, replacement of the wheel unit or of the sensor device can be detected when a predefined condition is respectively fulfilled for two or more of the plurality of sensor signal criteria. As a result, it is possible to conclude that a replacement has been carried out using logical links of sensor signal values, for example based on IF-THEN rules, such that an easy-to-implement and flexibly configurable possibility for processing the evaluation results is provided.

According to one embodiment, different priorities of the sensor signal criteria can be applied in the evaluation. For example, a positive result that represents completed replacement can be output when a particular sensor signal criterion has been met or a plurality of particular sensor signal criteria have been met independently of further sensor signal criteria. Alternatively or additionally, it is conceivable to weight sensor signal criteria differently, for example by assigning larger or smaller metrics when evaluating a sensor signal criterion and summing up the metrics to decide whether a replacement has taken place. Since some sensor signal criteria may be a stronger indicator for a possible replacement of the wheel unit or sensor device, a validity of the replacement detection can be increased if such sensor signal criteria are taken into account more during the evaluation or can be incorporated more into the result of the check.

According to an advantageous embodiment of the above-described embodiment, replacement of the wheel unit or of the sensor device is detected when a sensor loss signal exists. Accordingly, this sensor signal criterion can be prioritized over other sensor signal criteria. A sensor loss signal can be a reliable indicator for replacement of the wheel unit or of the sensor device, and is highly likely to indicate such a replacement. Depending on the configuration of the sensor device or of the tire pressure monitoring system, it may also be possible for the number of sensor signal criteria that are able to be evaluated to be reduced by the sensor loss indicated by the sensor loss signal, since following the sensor loss, the sensor signals thereof can no longer be evaluated. Therefore, it may be useful, when a sensor loss signal is received, to evaluate no further sensor signal criteria and to link the sensor loss signal to a result of a replacement of the wheel unit or of the sensor device.

According to one embodiment, in reaction to a detected replacement, a check can be made as to whether the detected replacement can be unambiguously assigned to a wheel unit or a sensor device. Such a check can subsequently also be referred to as a check for unambiguous assignability of the replacement. For example, a check can be made as to whether sensor signal criteria indicating a replacement exist only for a single sensor device, or a localization process can be initiated in order to identify the affected sensor device. This can prevent erroneous detection of a replacement and, for example, ensure that a subsequent reassignment of a new sensor device can be carried out correctly.

According to one embodiment, in reaction to a detected replacement of the wheel unit or of the sensor device or in reaction to unambiguous assignability of the detected replacement, a reassignment of a new sensor device can take place in the tire pressure monitoring system. For example, following a positive replacement detection or following a detected unambiguous assignability of the replacement, an automated detection and interrogation process for detecting a sensor ID of a new sensor device can proceed and a reassignment of the sensor ID to a wheel position stored for the previously replaced sensor device can take place. In particular, the reassignment can advantageously only be carried out when a previous unambiguous identification of the wheel unit and/or sensor device affected by the replacement has taken place. For example, an unambiguous identification of the wheel unit and/or sensor device affected by the replacement can take place if an evaluation of the sensor signal criteria a positive replacement result is achieved only for one wheel unit or only for one sensor device of the vehicle. This can reduce or eliminate a susceptibility to error in the reassignment. The reassignment of the new sensor device may be in particular an automatic reaction of the tire pressure monitoring system to a detected replacement, in which a user intervention is not necessary. As a result, a higher degree of automation is achieved than, for example, with a tire pressure monitoring system that reports a replacement but subsequently requires manual reassignment of a sensor device.

According to one embodiment, the plurality of sensor signal criteria can be evaluated during driving operation of the vehicle with a predefined minimum speed. Such a minimum speed may be, for example, 20 km/h, 30 km/h or 40 km/h. Advantageously, it is possible to check whether the predefined minimum speed is maintained for a predefined period of time. Advantageously, a one-time detection and evaluation of the sensor signal criteria can be carried out during driving operation and be repeated only after a standstill time with a predetermined minimum duration, for example a minimum duration of 10, 15 or 20 minutes, since a certain minimum time may usually be necessary for replacement of the wheel unit or sensor device. An evaluation time while the vehicle is being driven at a predetermined minimum speed represents a time, which is advantageous in terms of energy and control, for carrying out the checking procedure. For example, at the beginning of driving operation of the vehicle in the sense of the start of a journey, an energy- and interrogation-intensive state may arise at the tire pressure monitoring system and/or other vehicle systems in order, for example, to check safety-relevant parameters of the vehicle systems. As a result of the method being carried out during driving operation at a predefined minimum speed, such a starting state can be skipped and energy- and signal-processing resources of the vehicle can initially be spared. A one-time evaluation of the plurality of sensor signal criteria during driving operation also increases reliability of the checking process because the sensor signal criteria are checked at a time at which they can also be logically fulfilled. For example, an incorrect sensor loss signal caused by the initial absence of a sensor signal of the sensor device at the start of a journey can be avoided. Furthermore, it is possible, for example, for a susceptibility to error of the method and a high utilization rate of a control unit of the tire pressure monitoring system to be reduced compared with continuous evaluation and checking of the sensor signal criteria.

The disclosure furthermore relates to a tire pressure monitoring system for a vehicle having a wheel unit, which has a sensor device for sensing a tire pressure parameter and transmitting sensor signals to a receiving device of the tire pressure monitoring system, and having an electronic control unit for carrying out the above-described method. With the proposed tire pressure monitoring system it is likewise possible for the above-described advantages of automated replacement detection, increased user convenience, increased system integrity, a high degree of autonomy and flexible adaptability to be achieved. The receiving device of the tire pressure monitoring system can be connected to one or more sensor devices of wheel units of the vehicle via a suitable signal connection, for example a wireless signal connection. The electronic control unit of the tire pressure monitoring system may be configured to evaluate the sensor signals with regard to the sensed sensor variable and further sensor signal criteria. The electronic control unit may have a storage device for temporary and/or permanent storage of sensor signal values and criteria. Moreover, processing information, for example machine-readable command sequences, tables or evaluation rules, for carrying out the method can be stored in the storage unit. The electronic control unit may be a signal processing unit, for example, a processor, for processing the sensor signals received at the receiving device.

Furthermore, the disclosure also relates to an electronic control unit for a tire pressure monitoring system, which is configured to carry out the above-described method. The control unit may be in the form of a tire pressure control unit and may be configured, for example, to transmit tire pressure information to a display of the vehicle. The electronic control unit may be configured to evaluate sensor signals from wheel units of a vehicle having the tire pressure monitoring system with regard to the sensed sensor variable and further sensor signal criteria. The electronic control unit may have a storage device for temporary and/or permanent storage of sensor signal values and criteria. Moreover, processing information, for example machine-readable command sequences, tables or evaluation rules, for carrying out the method can be stored in the storage unit. The electronic control unit may have a signal processing unit, for example a processor, for processing the sensor signals received at the receiving device.

The disclosure furthermore relates to a vehicle, in particular a commercial vehicle, having a tire pressure monitoring system and/or an electronic control unit according to any of the above-described features. A commercial vehicle may be, for example, a towing vehicle, a trailer vehicle or a vehicle combination of a towing vehicle and a trailer vehicle. In principle, the disclosure is also usable on a passenger car. For a vehicle in the form of a commercial vehicle, additional advantages may arise or certain advantages may be more developed. For example, commercial vehicles, which may be configured, for example, for the transport of goods or relatively large numbers of people, may have a higher number of axles and wheel units than passenger cars, and so a probability of replacement of a wheel unit or sensor device may be increased and automated replacement detection may be associated with reduced maintenance effort for the vehicle driver. In addition, commercial vehicles may, depending on the configuration, have a lift axle, which, in a raised state, could result in characteristic sensor signals such as an abruptly reduced acceleration signal and could thus trigger an erroneous replacement detection, although this can be avoided as a result of the proposed evaluation of a combination of sensor signal values. As a result of the flexibility and adaptability in the selection and evaluation of suitable sensor signal criteria, an individually configurable and adaptable tire pressure monitoring system with a high degree of autonomy can be provided on the vehicle and the latter can accordingly be equipped with an improved tire pressure monitoring system.

### BRIEF DESCRIPTION OF DRAWINGS

The invention will now be described with reference to the drawings wherein:

FIG. 1 shows a basic diagram of a vehicle having a tire pressure monitoring system in a side view;

FIG. 2 shows a schematic flowchart of a method for detecting replacement of a wheel unit or sensor device of the vehicle;

FIG. 3 shows a basic diagram of a control unit of the tire pressure monitoring system; and,

FIG. 4 shows a table example for the evaluation of sensor signal values to form a result value.

### DETAILED DESCRIPTION

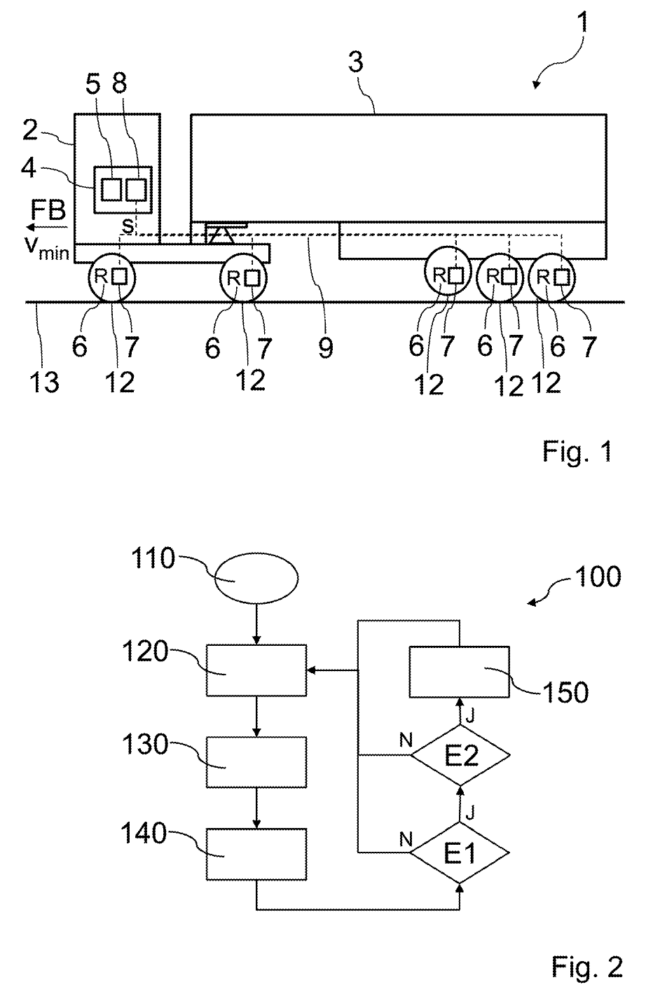

FIG. 1 shows a simplified basic diagram of a vehicle 1 for example in the form of commercial vehicle, which according to the illustrated embodiment, is configured as a vehicle combination having a towing vehicle 2 and a trailer vehicle 3. The vehicle 1 has a tire pressure monitoring system 4 with an electronic control unit 5 in the form of a tire pressure control unit, and a receiving device 8 for receiving sensor signals S. The vehicle 1 furthermore has a plurality of wheel units 6, each having a wheel 12 and a sensor device 7 arranged on the wheel 12. The sensor devices 7 are configured to sense a tire pressure parameter R of the wheel 12 on which they are arranged. The sensor devices 7 are connected to the receiving device 8 via signal connections 9, which may advantageously be wireless signal connections 9. Via the signal connections 9, sensor signals S can be transmitted from the sensor devices 7 to the receiving device 8 of the electronic control unit 5 of the tire pressure monitoring system 4. In FIG. 1, the vehicle 1 is shown in driving operation FB, in which it moves at a minimum speed vₘᵢₙ on a roadway 13, such that advantageously an evaluation of sensor signal criteria of the sensor signals S can be carried out according to the method 100 described below.

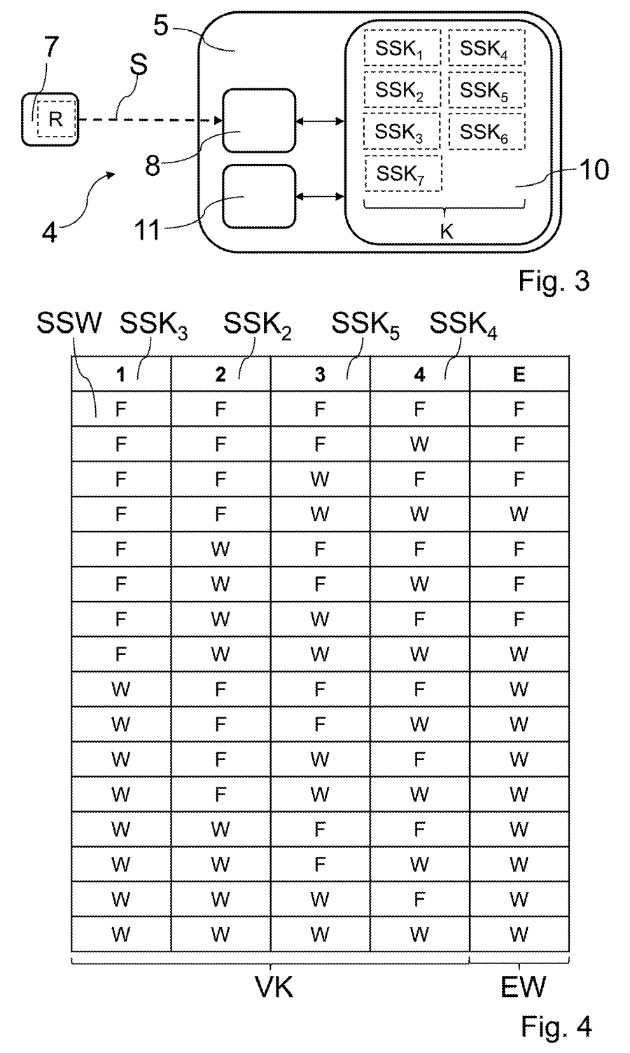

FIG. 2 shows a schematic flow diagram of a method 100 for detecting replacement of a wheel unit 6 having a sensor device 7 or replacement of the sensor device 7 of the wheel unit 6 of a vehicle 1 having a tire pressure monitoring system 4, as is illustrated, for example, in FIG. 1, wherein the sensor device 7 is configured to sense a tire pressure parameter R. According to the embodiment shown, after starting 110, the method 100 enters into a loop-like sequence. Sensor signals S are transmitted 120 continuously, for example at periodic intervals, from the sensor devices 7 of the wheel units 6 to a receiving device 8 of the tire pressure monitoring system 4. When correspondingly commanded by the control unit 5 of the tire pressure monitoring system 4, for example on account of a fulfilled condition such as driving operation FB with a minimum speed vₘᵢₙ, sensor signal criteria SSK₁ to SSK₇ that are explained and illustrated in more detail in FIGS. 3 and 4 are evaluated 130 to form a combination K of sensor signal values SSW. Based on the combination K of sensor signal values SSW, a decision E1 is made as to whether replacement of the wheel unit 6 or the of sensor device 7 has occurred E1-J or not E1-N. If it is decided that replacement of the wheel unit 6 or of the sensor device 7 has not occurred E1-N, the method continues with the continued transmission 120 of sensor signals S and, as commanded by the control unit 5, with a repeated evaluation 130 of the sensor signal criteria SSK₁ to SSK₇. If it is decided that replacement of the wheel unit 6 or of the sensor device 7 has occurred E1-J, a check is made according to the embodiment shown as to whether the detected replacement E1-J can be unambiguously assigned to a wheel unit 6 or a sensor device 7. If this is not the case, for example because an evaluation 130 of sensor signal criteria SSK₁ to SSK₇ reveals that several wheel units 6 are suitable for replacement, according to path E2-N, the method continues with the continued transmission 120 of sensor signals S and, as commanded by the control unit 5, with a repeated evaluation 130 of the sensor signal criteria SSK₁ to SSK₇. However, if it is decided E2-J that there is unambiguous assignability of the detected replacement E1-J, reassignment 150 of a new sensor device 7 in the tire pressure monitoring system 4 takes place. Subsequently, the method continues with the continued transmission 120 of sensor signals S and, as commanded by the control unit 5, with a repeated evaluation 130 of the sensor signal criteria SSK₁ to SSK₇.

FIG. 3 schematically shows a tire pressure monitoring system 4 having an electronic control unit 5, which has a signal processing unit 10, a receiving device 8 and a storage unit 11. At the receiving device 8, sensor signals S from the sensor device 7 relating to a tire pressure parameter R of the wheel unit 6 having the sensor device 7 can be received, for example, wirelessly and be transferred to the signal processing unit 10. In the signal processing unit 10, sensor signal criteria SSK₁ to SSK₇ can be evaluated to form a combination K of sensor signal values SSW schematically indicated in FIG. 4, in order to detect replacement of the wheel unit 6 or of the sensor device 7 based on the combination of sensor signal values SSW. For example, the sensor signal criterion SSK₁ can represent a battery warning signal, the sensor signal criterion SSK₂ can represent a pressure loss warning signal, the sensor signal criterion SSK₃ can represent a sensor loss warning signal, the sensor signal criterion SSK₄ can represent a signal strength fluctuation of the sensor signal S, the sensor signal criterion SSK₅ can represent an acceleration signal, the sensor signal criterion SSK₆ can represent a direction of rotation signal, and the sensor signal criterion SSK₇ can represent a driving status signal. As required, the sensor signals S can be stored in the storage unit 11 such that an evaluation of the sensor signal criteria SSK₁ to SSK₇ can also be carried out at a later time after the reception of the sensor signals S at the receiving device 8.

FIG. 4 shows a table example for the evaluation of sensor signal values SSW to form a result value EW, wherein, according to the embodiment shown, the sensor signal criteria SSK₂, SSK₃, SSK₄ or SSK₅ are considered. Comparison combinations VK of sensor signal values SSW with respectively assigned result values EW are stored in the table, such that a determined combination of sensor signal values SSW can be compared with the comparison combinations VK and an assigned result value EW can be determined for a combination of sensor signal values SSW. According to the illustrated embodiment, the sensor signal values SSW are binary and represented by truth values with the possible values W for True and F for False, so that a qualitative evaluation can take place. The truth values of the sensor signal values SSW may, for example, indicate whether a predefined condition has been met (true) or has not been met (false) for the respective sensor signal criterion SSK₂, SSK₃, SSK₄ or SSK₅. The result values EW, which are likewise illustrated as truth values, may indicate, for example, whether a decision is made (true) or a decision is not made (false) to replace the wheel unit 6 or the sensor device 7. As can be seen from the result values EW assigned to the sensor signal criterion SSK₃ corresponding to a sensor loss warning signal, this sensor signal criterion SSK₃ is given a higher priority since the result value EW assumes a positive truth value (true) independently of the further sensor signal values SSW if the condition of a sensor loss warning signal as the sensor signal value SSW has been met (true). If there is no sensor loss warning signal, it is possible, for example, for the rule to be followed that two or more of the sensor signal values SSW must assume a positive truth value (true) in order to obtain a positive result value EW (true), wherein, depending on individual logics, exceptions can be made for certain sensor signal criteria SSK, as is illustrated here by way of example in the case of the sensor signal criteria SSK₂ and SSK₄.

With the presented method 100, the vehicle 1, the tire pressure monitoring system 4, and the electronic control unit 5, it is possible to realize automatic replacement detection, which is accompanied by increased user convenience, increased system integrity, a high degree of autonomy, and flexible adaptability.

It is understood that the foregoing description is that of the preferred embodiments of the invention and that various changes and modifications may be made thereto without departing from the spirit and scope of the invention as defined in the appended claims.

### REFERENCE SIGNS PART OF THE DESCRIPTION

1 Vehicle

2 Towing vehicle

3 Trailer vehicle

4 Tire pressure monitoring system

5 Control unit

6 Wheel unit

7 Sensor device

8 Receiving device

9 Signal connection

10 Signal processing unit

11 Storage device

12 Wheel

13 Roadway

100 Method

110 Start

120 Transmission of sensor signals

130 Evaluation of sensor signal criteria

140 Comparison of sensor signal values with comparison combinations

150 Reassignment of a new sensor device

E1 Decision for replacement

E1-J Positive decision for replacement

E1-N Negative decision for replacement

E2 Check for the assignability of the replacement

E2-J Positive decision for assignability

E2-N Negative decision for assignability

EW Result value

F False

FB Driving operation

K Combination of sensor signal values

R Tire pressure parameter

S Sensor signal

SSK Sensor signal criterion

SSK1 Battery warning signal

SSK2 Pressure loss warning signal

SSK3 Sensor loss signal

SSK4 Signal strength fluctuation of the sensor signal

SSK5 Acceleration signal

SSK6 Direction of rotation signal

SSK7 Driving status signal

SSW Sensor signal value

Vmin Minimum speed

VK Comparison combination

W True

1. A method for detecting a replacement of a wheel unit having a sensor device or a replacement of the sensor device of the wheel unit of a vehicle having a tire pressure monitoring system, wherein the sensor device is configured to sense a tire pressure parameter and to transmit sensor signals to a receiving device of the tire pressure monitoring system, the method comprising:
evaluating a plurality of sensor signal criteria of the transmitted sensor signal in order to determine a combination of sensor signal values; and,
detecting, on a basis of the combination of sensor signal values, the replacement of the wheel unit or of the sensor device.

2. The method of claim 1, wherein the plurality of sensor signal criteria include at least one of:
a battery warning signal;
a pressure loss warning signal;
a sensor loss signal;
a signal strength fluctuation of the sensor signal;
an acceleration signal;
a direction of rotation signal; and,
a driving status signal.

3. The method of claim 1, wherein, to determine the combination of sensor signal values, a check is made as to whether the plurality of sensor signal values respectively fulfill a predefined condition.

4. The method of claim 1 further comprising:
comparing the determined combination of sensor signal values with stored comparison combinations of sensor signal values; and,
assigning each comparison combination of sensor signal values a result value.

5. The method of claim 1, wherein the replacement of the wheel unit or of the sensor device is detected when a predefined condition is respectively fulfilled for two or more of the plurality of sensor signal criteria.

6. The method of claim 1, wherein different priorities of the plurality of sensor signal criteria are applied in said evaluation of the plurality of sensor signal criteria.

7. The method of claim 6, wherein the replacement of the wheel unit or of the sensor device is detected when a sensor loss signal exists.

8. The method of claim 1, wherein, in reaction to a detected replacement, a check is made as to whether the detected replacement is unambiguously assignable to the wheel unit or the sensor device.

9. The method of claim 1, wherein, in reaction to detecting the replacement of the wheel unit or of the sensor device or in reaction to an unambiguous assignability of the detected replacement, a reassignment of a new sensor device takes place in the tire pressure monitoring system.

10. The method of claim 1, wherein the plurality of sensor signal criteria are evaluated during driving operation of the vehicle with a predefined minimum speed.

11. A tire pressure monitoring system for a vehicle having a wheel unit, the tire pressure monitoring system comprising:
a receiving device;
a sensor device configured to sense a tire pressure parameter and transmit a sensor signal to said receiving device;
an electronic control unit configured to:
evaluate a plurality of sensor signal criteria of the transmitted sensor signal in order to determine a combination of sensor signal values; and,
detect, on a basis of the combination of sensor signal values, a replacement of the wheel unit or of said sensor device.

12. An electronic control unit for a tire pressure monitoring system, configured to carry out the method of claim 1.

13. A vehicle comprising:
a wheel unit;
a tire pressure monitoring system;
a receiving device;
a sensor device configured to sense a tire pressure parameter and transmit a sensor signal to said receiving device;
an electronic control unit configured to:
evaluate a plurality of sensor signal criteria of the transmitted sensor signal in order to determine a combination of sensor signal values; and,
detect, on a basis of the combination of sensor signal values, a replacement of said wheel unit or of said sensor device.

14. The vehicle of claim 13, wherein the vehicle is a commercial vehicle.

15. A vehicle comprising the electronic control unit of claim 12.

16. The vehicle of claim 15, wherein the vehicle is a commercial vehicle.
